(19) United States
(12) Patent Application Publication
(10) Pub. No.: US 2013/0307777 A1
(43) Pub. Date: Nov. 21, 2013

(54) Input Device, System and Method Using Event Signal Coding

(71) Applicants: Chi-Chang Liu, Concord, CA (US); Philip Liu, Concord, CA (US); Young-Ming Wu, Concord, CA (US)

(72) Inventors: Chi-Chang Liu, Concord, CA (US); Philip Liu, Concord, CA (US); Young-Ming Wu, Concord, CA (US)

(21) Appl. No.: 13/472,497

(22) Filed: May 16, 2012

(51) Int. Cl. G06F 3/033

(52) U.S. Cl. 345/163

(57) ABSTRACT

Method implementing a generic computer human input device using key event signal coding compliant to the standard protocols so as to expand its application range without losing plug-and-play property. Applications of the present invention include audience response, gaming, legacy system support and cross-platform system integration, for example.

### FIELD OF THE INVENTION

The invention relates to a portable plug-and-play computer human input device with expanded capabilities. More specifically, this invention relates to an expanded mouse based human input device that performs pointer control function, mouse button functions and user data input function using standard HID protocols.

### BACKGROUND

Despite of the intuitive operation style and the emulation ability of the touch screens, the keyboard and the mouse are still the most popular human input devices (HID) for computers at present time. With the convenience of computer graphics interface, the pointer control and mouse key functions have already become just as important, if not more, as the keyboard input functions for almost all computer users.

Keyboards are designed primarily for “one letter at a time” alphanumeric character user data input. Therefore, limited by their linear buffer implementation, no key board is capable to store two alphanumeric keys, modifier keys excluded, in parallel, even if they are indeed pressed simultaneously by the user. Mouse buttons, on the other hand, are event generators to alert the CPU about the user's intent to take certain actions at the present screen pointer location. Therefore, mouse keys may be simultaneously used and registered to activate all the related events at the same time. With this property the mouse has grown to become an even more important input device than keyboard for certain types of computer applications.

Traditional keyboard implementations require a relatively large surface area for key placement. In order to reduce the surface area without overcutting the size of the keys, some keyboards are designed without a full key set. For example, the invention described in U.S. Pat. No. 3,967,273 uses a 3 by 4 array of buttons to implement the entire alphanumeric key set; each button carries multiple key assignments, which are selected sequentially by repeating button pushes. Other inventions, such as the devices described in U.S. Pat. Nos. 4,042,777, 7,492,286 B2 and 7202853 B2, require multiple steps or serious user training for character selection. Consequently, both the ergonomics and the efficiency may suffer greatly in these devices.

Prior art mouse implementation frequently uses an easy-to-grab form factor so as to facilitate accurate pointer control by hand movement. The form factor, including size requirement, limit the number of buttons that can be reasonably implemented on the device without seriously degrading its ergonomics and efficiency. The majority of the present mouse offers 3 to 5 keys.

Deficiencies with prior art mouse and keyboards can be further illustrated from a few applications' view point. For example, the Audience Response Systems (ARS's) collecting audience feedback in real-time to help facilitate discussions and concept promotion have been used for teaching, researching, test-taking and voting applications. From business meetings to classroom teaching, when properly applied, ARS has demonstrated its value in producing measurable improvement of presentation effectiveness, partially because the audience can give feedback in a pre-defined simple form anonymously and conveniently and that the feedback can be reviewed by the presenter almost instantaneously.

Traditionally, all ARS's use a handheld device, commonly called the “clicker”, for the audience to select and send their responses to a question. Because the uses of the ARS's have been focused on collecting user feedback in a pre-defined form, most clickers are designed as miniature keypads or TV remotes with a smaller set of keys, each key preprogrammed to a specific command for data selection and sending, for instance. Some clickers also offer a set of arrow keys and/or a small touch screen for crude pointer position control and/or short text messaging to the host CPU. However, because of performance limitations and application time constraints, they have not been used as much as expected.

Most ARS hand device are wireless device for convenience. Three wireless technologies are currently used for ARS applications. They are: infrared (IR), Radio Frequency (RF) and Wi-Fi. The IR ARS's require an unobstructed line of sight between a carefully installed receiver and the clickers. And, the more receivers in use, the more potential there is for signal interference. The RF ARS's do not require line-of-sight transmission and with a single receiver capable of working with over 1000 clickers. In theory, the Wi-Fi systems may include almost any Wi-Fi based input device; including: smart phones, PDAs, laptops, tablets, and etc., for as long as the Web browsers on the individual devices interact well with the host hardware, while the ARS application software is executed on a host computer or a network server. Therefore, it may offer the highest flexibility and the lowest cost of ownership to the meeting host. In reality, however, unless the entire Wi-Fi ARS, from the infrastructure to the individual user input devices, are qualified and carefully managed, the performance and the reliability of an ad-hoc ARS using user-supplied input devices can be very unpredictable. With the additional risk of the audience getting distracted by other on-line activities when they use their personal Wi-Fi devices in an ARS session, the Wi-Fi based ad-hoc ARS's are facing difficulties to be accepted as serious productivity tools.

Because almost all the non-ad-hoc ARS clickers are designed to be passive response devices, they provide no practical means for the user to actively interact with the presentation host or with the other audience. For example, a participant may need to mark, draw or even drag-and-drop items displayed on the presentation screen to explain the reason of his answer to a question. These operations require precision pointer control that is beyond the ability of all prior art clickers except one. The AVerPen from AverMedia INFORMATION is a pen style wireless clicker system based on a proprietary technology. The system operates in groups of 5 units: a master unit and 4 student units. The master unit is a wireless optical mouse without the clicker functions. It is the only unit in the group connecting to the CPU and responsible for all 5 units' communication to the CPU. The students units are controlled by the master unit and must go through the master unit to connect to and communicate with the CPU. The student unit can't be used as a regular mouse or an independent input device. It has 6 selection buttons for answer selection and can only be used with the AVer software for hand drawing input. The AVerPen master unit carries a retail price of over USD 100.00 a piece, many times higher than the average price of a mouse.

The multi-mouse computer technology developed recently allows multiple computer mice to be used simultaneously and independently on a CPU without interfering each other makes the traditional mouse, or, any pointer control device, a familiar and economic interactive device for computer based group interactive activities, especially when drag-and-drop or hand-drawn pattern creations on a display screen are needed. The particular multi-mouse software from Microsoft, called MultiPoint, for example, further opens up the possibility of using the mouse keys to simulate the clicker functions in the MS PowerPoint environment without the typical clicker's compatibility issues.

The primary issues today with using the prior existed mouse for multi-mouse application is the lack of user data input function. That is, typical computer mouse offer 3 to 5 mouse keys which are not suitable for data input use. Even when a key chording method is to be used for user data input, considering that user may not be able to operate more than 3 keys at a time, a 5-key mouse would be limited to the possible total permutations of 25 and lacking feedback in any form for user to confirm their input value. Additionally, user would have to either use a reference card or take training before start using the key chording input method for data input. These practices are not only impractical but also exposed to the risk of user data corruption due to accidental unintended key presses.

Many mouse and keyboard integrated devices exist. For example, the invention described in U.S. Pat. No. 5,457,480 integrates a keypad into a mouse body to allow user to either type of functions depending on the position of a switch. Another prior art device described in U.S. Pat. No. 8,130,200 B2 offers a more convenient keyboard interface and mode selection mechanism. Although these devices may work well as a standalone input device, they don't work for the multi-mouse supplication because the inputs from the multiple keyboards would interfere and overlap each other.

Another potential multi-mouse application is the computer gaming, which would allow multiple users to participate in a group game using a single computer. Up to date the mouse and the keyboard have been the only standard input devices utilized in the computer gaming industry programming practice. Because the player in most first- and third-person action games frequently use the mouse to move the first-person or an object, whose position may be represented by the invisible center-of-gravity point, for example, to the desired position while giving other commands, gaming mice often come with more buttons to allow the player to accomplish both actions using just the mouse. However, due to the physical limitations of the player and the device, the number of buttons can be comfortably placed on a regular size mouse is limited. The most common existing solution to this problem is to use a mapping table in the mouse driver so that the user may choose a different mapping table to modify the device command associated to each mouse key when needed. This solution does not work well for fast action games, especially when team-playing is involved, because the player must either put the game on pause or ignore his role in the game when going through the driver control interface to change the mapping table. Another existing solution to this problem is to expand the number of the buttons on the mouse. As an extreme example, the Razer Naga Epic Mouse has 17 buttons, 12 of them are placed in a tight cluster in the thumb area. According to a gamer's on-line comment, it took him 18 hours practice to get used to the buttons.

There is a clear need of a better solution to providing a larger set of mouse key commands in a generic pointer control device without the loss of convenience or ergonomics for the computer based group interaction applications.

### PURPOSE OF THE INVENTION

Thus, it is an object of the present invention to provide an improved plug-and-play portable input device with a relatively small set of buttons yet capable of offering all the critical human input functions; including: pointer control, mouse buttons and a relatively large set of different input commands.

Another object of the present invention is to create an improved multi-mouse system using an improved mouse based device and input method so as to bring the user experience in group interactivities to a higher level. Another objective of the present invention is to provide a method to expand the applicability of a generic human input device to a computing or electronic device that may be incompatible to the input device or requiring a larger command set than what's available from the input device to operate originally.

### BRIEF SUMMARY OF THE INVENTION

A plug-and-play portable HID device with pointer control, mouse buttons and simple user data input functions without using a large number of keys or requiring user to learn chorded key patterns is provided. The pointer control module may be based on the optical navigation technology, commonly used by an optical mouse or a laser mouse, and the device is preferred to be implemented as a wireless device for user convenience sake.

Although the present invention may be implemented as a composite device, for practical considerations, including: cost, performance and compatibility, the present invention is preferred to be implemented using just one HID device identity, namely the mouse, so as to be able to operate on some of the most popular operating systems, such as the Microsoft Windows XP, Vista and 7 with up to 5 mouse buttons and a scroll wheel without the need of a custom device drivers. Additionally, the choice of the mouse device identity alone works perfectly well with the available multi-mouse technologies developed by Microsoft and other software companies to allow for multiple mouse operating on one computer independently and without interfering each other. To overcome the total lack of user data input capability in a HID mouse device, the present invention uses a novel mouse key event-scroll motion signal combined coding scheme to make available up to at least hundreds of different command signals without the need of invoking any keyboard commands.

The present invention may further comprise a display panel to display the current status of the device and other important information. Alternatively, status and indicator lights may be used or added to replace or complement the display panel. When a touch sensitive display panel is used in the present invention, that touch panel may be used for command/data generating purposes as well.

In some applications, such as: quiz-taking in a computer based interactive classroom teaching session or board of director voting session, assuring the user identity of each device is crucial. The present invention may use an identity identification mechanism, such as: a finger print scanner or a button/encoder-generated passcode lock, for example, to identify the device user before allowing critical action taking place. Additionally, the device in the present invention may further comprise a memory means to bookkeep all the commands that have been sent by the device user for reference, backup and diagnosis purposes, for example.

### BRIEF DESCRIPTION OF THE DRAWINGS

FIG. 1 shows an exemplary embodiment of the present invention using the common soap-bar shaped mouse body.

FIG. 2 shows an exemplary embodiment of the display screen 105 in the clicker mode of the embodiment in FIG. 1.

FIG. 3 shows an exemplary embodiment of the present invention using a barrel-shaped pen mouse body.

FIG. 4 shows another exemplary embodiment of the present invention in a barrel-shaped pen mouse body.

FIG. 5 shows another exemplary embodiment of the present invention in a soap-bar shaped body.

FIG. 6 shows an exemplary embodiment of the display screen 505 in the clicker mode.

FIG. 7 shows another exemplary embodiment of the present invention in a soap-bar shaped body.

### DETAILED DESCRIPTION OF THE DRAWINGS

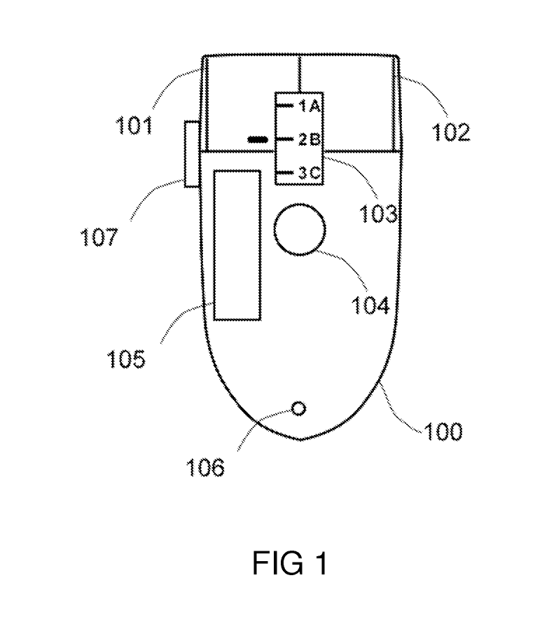

FIG. 1 shows an exemplary embodiment of the invention that uses the HID mouse device identity and a common soap-bar shaped wireless mouse body 100. An optical navigation module, not shown in the drawing, is used by the device for pointer control. The device also contains a wireless transmission module, not shown in the drawing, for transmitting commands to a receiver that is not shown in this drawing and connected to or built into the CPU, which is not shown in this drawing. The mode select button 104 allows the user to select the mouse mode, the clicker-I mode or the clicker-II mode. The present device mode is shown on the display screen 105. In the mouse mode, the Left Mouse Button 101 works as the left mouse button and the Right Mouse Button 102 works as the right mouse button. In the clicker-I and clicker-II modes they work as the Select and the Send Command Buttons, respectively. The rotary encoder 103 also has a built-in press-down switch for the mouse third button function. A fourth mouse button 107 is placed on the left side of the device body 100. In the mouse mode the rotary encoder 103 works as the mouse scroll wheel. In the clicker-I mode, it work as a response selector, sequentially going through the possible responses, marked by numbers 1 through 10 on the rotary encoder 103. When the clicker-II mode is selected, the rotary encoder generates responses from A to J, which are marked next to the number markings. The display screen 105 shows the present operation mode of the device: mouse mode, clicker-I mode or clicker-II mode. In the clicker modes, the present encoder selection is also shown on the display screen 105. Additionally, in the clicker modes, the display screen also shows operational clock information. To overcome the lack of user data input capability in a HID compliant mouse device, this embodiment of the present invention uses a mouse key event based coding scheme to represent the desired user input value, say, between 1 to 10 in clicker-I mode. That is, by reserving the Left #5 Key as a code marker, the group of key event signals Left #1 Key Down+Left #5 Key Down is used to represent the value of 1, the group of key event signals Left #1 Key Down+Left #2 Key Down+Left #5 Key Down is used to represent the value of 1 plus 2, the group of key event signals Left #2 Key Down+Left #4 Key Down+Left #5 Key Down is used to represent the value of 2 plus 4, and etc. The key event group signals are implemented with the corresponding dial position on the rotary encoder and are processed accordingly on the application side that receives these key events as if they were created by the user manually, while in fact, by design, the user can't even manually compose them on the device. After a predefined time period following the sending of the group of key event signals, the present invention sends a corresponding group of key event signals to return all the keys back to the Up state. TABLE 1 shows one of the coding schemes that may be used to produce user input for value from 1 to 10. A similar scheme but with a double-click Left Key #5 signal instead is used for the clicker-II mode to generate a character input from A to J. To operate the user data input function the user first rotates the rotary encoder to the right position. The user then presses the mode selector 104 once to go to the clicker-I mode or twice to the clicker-II mode. The user presses the Left Mouse Button once to complete the selection and then confirms the selection as shown in display screen. The user then presses the Right Mouse Button once to send out the selection. After the user has made the selection in a clicker mode, the selection value is updated in the display window and all mouse buttons are disabled except the Right Mouse Button and the mode selector. The user then may use the Right Mouse Button to send in the data or the Mode Selector to cancel the selection and return to the Mouse mode. In one embodiment, the present invention uses a countdown clock to allow the device to return to the pre-selection mode if the send button is not pressed in 30 seconds after the Select button is pressed. A proximity sensor 106 senses if a user's hand is away from the top surface of the device so as to turn off the power to certain parts of the device to conserve power stored in the device power pack, which is not shown in the drawing.

TABLE 1

| Mouse | | | | | | | | | | |
|---|---|---|---|---|---|---|---|---|---|---|
| Key | Event Signal Used in Code | | | | | | | | | |
| Left #1 | ✓ | | ✓ | ✓ | ✓ | | | ✓ | | ✓ |
| Left #2 | | ✓ | ✓ | | | ✓ | | | ✓ | ✓ |
| Left #3 | | | | ✓ | | | ✓ | ✓ | ✓ | ✓ |
| Left #4 | | | | | ✓ | ✓ | ✓ | ✓ | ✓ | ✓ |
| Left #5 | ✓ | ✓ | ✓ | ✓ | ✓ | ✓ | ✓ | ✓ | ✓ | ✓ |
| Input | 1 | 2 | 3 | 4 | 5 | 6 | 7 | 8 | 9 | 10 |
| Value | | | | | | | | | | |

On the receiver side, not shown in the drawing, in one embodiment of the present invention the received signal is processed by an application-specific event handler to translate the input signal into the corresponding input date form before applying to the application. That is, if the received signal is not received with a Left Mouse Key #5 activated, it will be handled as a regular mouse action. Otherwise, the received signal will be translated by TABLE 1 to extract the user input value and then processed.

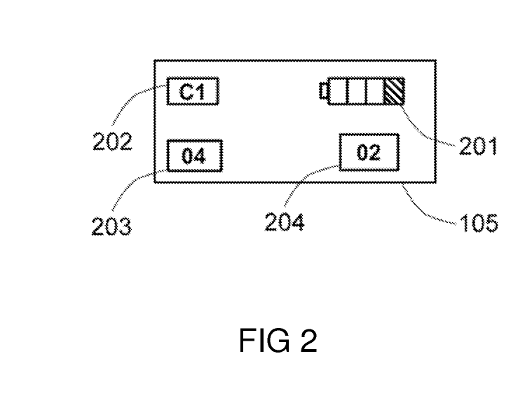

FIG. 2 shows an exemplary embodiment of the display screen 105 in the clicker mode of the embodiment in FIG. 1. The battery symbol 201 with 4 on/off segments on the upper top corner of the display screen 105 shows the present power source condition of the device, when it uses an on-device power source. The text c1 in the mode indicator window 202 in the upper left corner of the display screen 105 shows the device is presently in the clicker-I mode. On the lower part of the display screen 105, to the left side of the antenna symbol is the current selection window 203, displaying a 2-digit number presently selected by the user. The 2-digit window 204 on the right side shows the remaining time on the clock before the present selection lock expires.

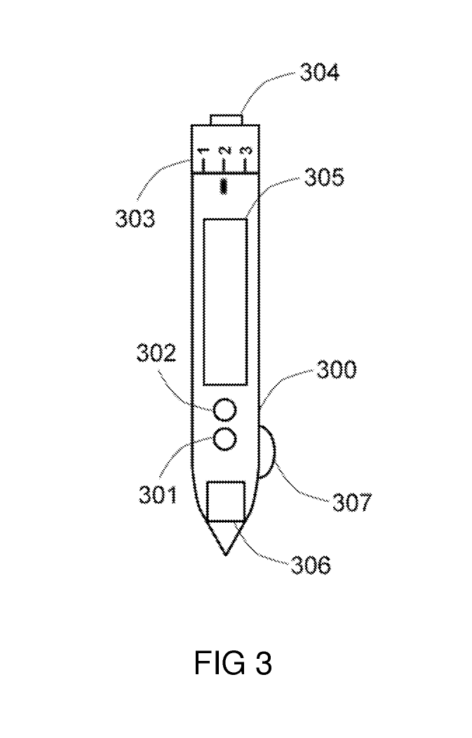

FIG. 3 shows an exemplary embodiment of the present invention using a barrel-shaped pen mouse 300 as the basis. An optical navigation module 306 is place near the lower tip of the device. The mode select/input select/send button 304 allows the user to select between the mouse mode and the clicker mode, to lock the user input data and to send that locked user input data. The display screen 305 displays the present device mode, which is not shown in the drawing. In the mouse mode, the Left Mouse Button 301 works as the left mouse button and the Right Mouse Button 302 works as the right mouse button. In the clicker mode they are disabled along with the navigation module 306. A co-axially oriented rotary encoder 303 with equally spaced sequential markings from 1 through 8 is placed at the upper end of the barrel and working in the clicker mode as a response selector. In the clicker mode, the present selection is shown on the display screen 305 along with the last selection that was successfully sent out to the receiver, which is not shown in the drawing. A second rotary encoder 307 is used for mouse scroll wheel function with a built-in third mouse button. For clicker data input operation, the user first presses the mode selector 304 to enter the clicker mode and disable all the mouse functions. The user then uses the rotary encoder 303 to select the answer. The user then presses the mode selector 304 to lock in that selection and update the display content on the display screen 305. Once the answer is locked in the user is given a predefined time period to either complete the send action or return to the pre-lock-in state. During that count-down period, the user may also use the mode selector 304 to abandon the selection and return the device 300 to the regular mode.

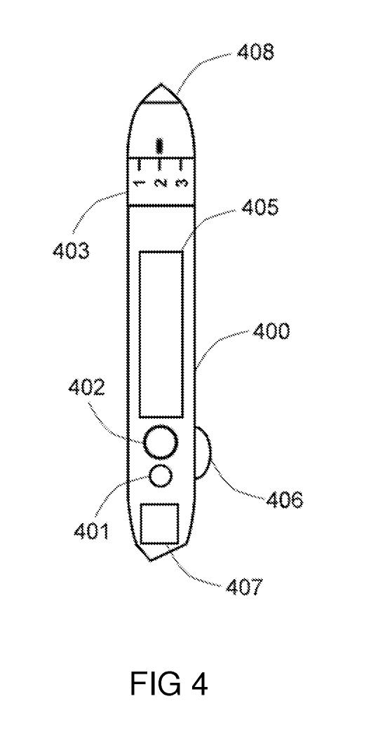

FIG. 4 shows another exemplary embodiment of the invention using a barrel-shaped pen mouse 400 as the basis. The barrel-shaped body and the stylus tip 408 are made of static-conductive material or finish so that it may be used as a stylus for capacitive touch panels. The mode select button is implemented under the scroll wheel 406 to allow the user to select between the mouse mode and the clicker mode. The display screen 405 shows the present device mode, which is not shown in the drawing. In the mouse mode, the Left Mouse Button 401 works as the left mouse button and the Right Mouse Button 402 works as the right mouse button. In the clicker mode they work as the Select Button and the Send Command Button, respectively, while the optical navigation module 407 is turned off. A co-axially oriented rotary encoder 403 is placed at the upper end of the barrel and working only in the clicker mode as a response selector. It is marked with equally spaced sequential numbers from 1 through 10. A second rotary encoder 406, which also has a built-in button for mode selection, is placed in a perpendicular fashion for easy thumb operation and with 6 equal-spaced markings: A, B, C, D, E and F, which are not shown in the drawing. In the mouse mode, the second rotary encoder 406 is used for mouse scroll wheel function. In the clicker mode, the present selection is made up by using both rotary encoders 406 and 403 to form a 2-alphanumerical digit code, such as A4, with a total of 60 possible choices. In this embodiment the display screen 405 displays the present selection code and the last selection that was successfully sent out; both codes are not shown in the drawing. In this embodiment the Right Mouse Button 402 also has a finger scanner built on its top surface so that the identity of the user can be identified before the Send command can be activated. This embodiment of the present invention uses a mouse key event signal and pointer position signal based coding scheme to implement the 60 input selections signals. That is, by expanding the coding length in TABLE 1 to include a pointer position movement signal to encode the tenth digit value, the 60 protocol compliant input selection signals can be easily implemented. Therefore, the group of key event signals Left #1 Key Down+Left #5 Key Down+Pointer Position Move X=1, Y=0 is used to represent the value of 11, the group of key event signals Left #1 Key Down+Left #5 Key Down+Pointer Position Move X=0, Y=1 is used to represent the value of 21, the group of key event signals Left #1 Key Down+Left #5 Key Down+Pointer Position Move X=−1 Y=0 is used to represent the value of 41, and etc. More specifically, the embodiment adds an artificially generated Pointer Position Move X=1, Y=0 signal to the to all the single-digit input value codes in TABLE to create input value from 11 to 20, Pointer Position Move X=0, Y=1 signal to create input value from 21 to 30, Pointer Position Move X=1, Y=1 signal to create input value from 31 to 40, Pointer Position Move X=−1, Y=0 signal to create input value from 41 to 50, Pointer Position Move X=0, Y=−1 signal to create input value from 51 to 60. After the selection sending is completed, the embodiment sends out a reverse pointer position movement signal to return the pointer to its position prior to the selection sending.

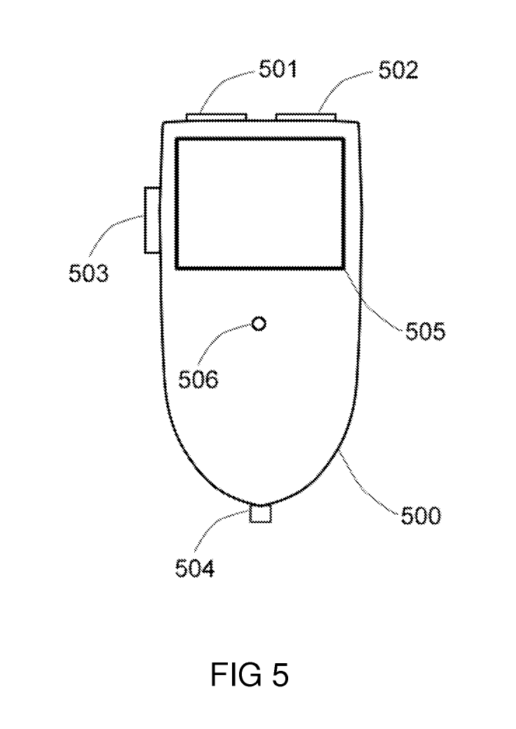

FIG. 5 shows another exemplary embodiment of the invention in a soap-bar shaped body 500. An optical navigation module, not shown in the drawing, is used by the device. The device also contains a wireless transceiver module, not shown in the drawing, for transmitting and receiving signals to and from a receiver, which is not shown in the drawing and may be connected to or built into the CPU, which is not shown in this drawing. The mode selector 504 is a 3 position switch, is used to select the mouse mode or clicker mode and to turn the device power off. The touch sensitive display screen 505 is only activated in the clicker mode and working as both a display and an input means. In the mouse mode, the Left Mouse Button 501 works as the left mouse button and the Right Mouse Button 502 works as the right mouse button. In the clicker modes they work as the Select and the Send Command Buttons, respectively. In the mouse mode the rotary encoder 503 works as the mouse scroll wheel and also the third mouse button. In the clicker mode, it work as an alternative selector, sequentially going through the possible selections as displayed on the present screen when the wheel is rotated. The display screen 505 shows the present operation mode of the device: mouse mode or clicker mode. In the clicker modes, the present encoder selection is also shown on the display screen 105. Additionally, in the clicker mode, it also shows the last response that was successfully sent to the receiver. A proximity sensor 506 senses if a user's hand is away from the top surface of the device so as to turn off the power to certain parts of the device to reserve power.

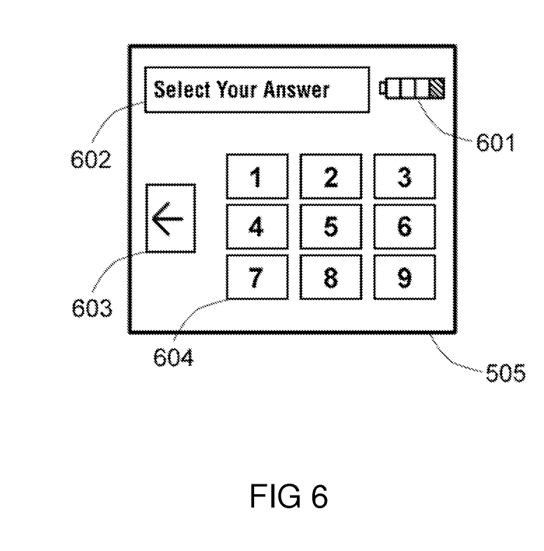

FIG. 6 shows an exemplary embodiment of the display screen 505 in the clicker mode. The battery symbol 601 with 4 on/off segments on the upper top corner of the display screen 505 shows the present power module condition of the device. The line of text “Select Your Answer” 602 in the upper left part of the screen 505 shows the present state of the device. In the center of the screen 505 is a group of buttons with numeral markings for the user to select. A representative button 604 is marked by the number 7. A Back Button 603 is in the left area of the screen 505 for returning to the previous screen display. The content of the display window 505 changes as the user goes through each operation.

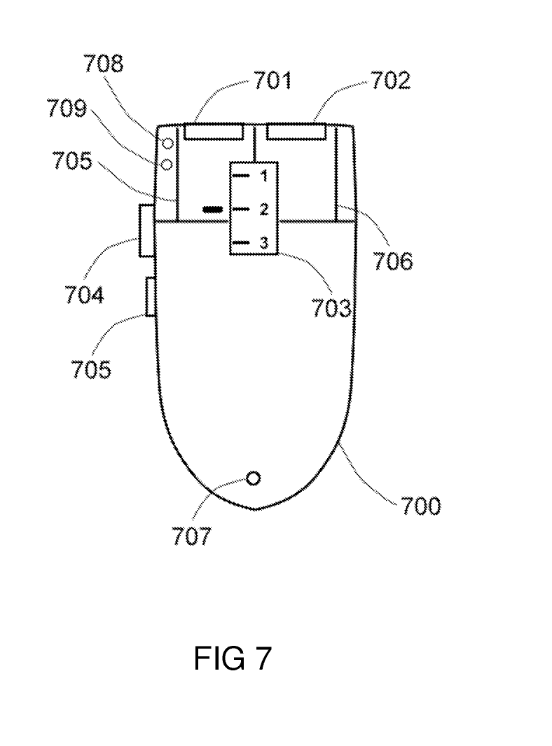

FIG. 7 shows another exemplary embodiment of the invention in a soap-bar shaped body 700. An optical navigation module, not shown in the drawing, is used by the device. The device also contains a wireless transceiver module, not shown in the drawing, for transmitting and receiving signals to and from a receiver, which is not shown in the drawing and may be connected to or built into the CPU, which is not shown in this drawing. The mode selector 705 is used to select the Mouse Mode, Clicker-I or Clicker-II Mode. In the Mouse Mode, the Left Mouse Button 701, placed on the upper left rim of the top surface, works as the left mouse button, the Right Mouse Button 702, placed on the right upper rim of the top surface, works as the right mouse button. The third mouse button is placed under the rotary encoder 703, the fourth mouse button 704 is place on the left side of the body 700 and two more buttons: 705 and 706, are placed close to the left and the right mouse buttons, respectively, surrounding the left and right mouse buttons in a cut-out fashion. When the Clicker-I Mode is activated, all mouse button commands are amended by adding an Alt Key Hold signal. For example, the Left Mouse button would activate the Left Button Down+Alt Key Hold command signal. When the Clicker-II Mode is activated, all mouse buttons are amended by adding the Ctrl Key Hold signal. For example, the Right Mouse button would activate the Right Button Down+Ctrl Key Hold command signal. Altogether, this embodiment offers 18 buttons in three operation modes. In the Mouse Mode the rotary encoder 703 works as the mouse scroll wheel and also the third mouse button. In the Clicker modes, it work as an alternative selector, sequentially going through the possible selections as marked on the scroll wheel. Two indicator lights 708 and 709 are used as the Clicker-I and Clicker-II Mode indicators, respectively. A proximity sensor 707 senses if a user's hand is away from the top surface of the device so as to turn off the power to certain parts of the device to conserve energy. The device also contains a memory unit, not shown in the drawing, to keep a record of at least the last 1000 user data that has been sent out with time stamps so that it may be checked against what's received by the CPU, for example, if ever needed.

While the invention has been described, for illustrative purposes and in connection with what may be considered most practical and preferred embodiment at the present time, it is to be understood that the present invention is not to be limited to the disclosed embodiment, but on the contrary, is intended to cover various modifications and equivalent arrangements included within the spirit and scope of the appended claims.

What is claimed is:

1. A computer input device having user data input ability comprising:
a data transmission module;
a body; and
a signal generating means capable of generating a plurality of single HID mouse key event signals and at least one preprogrammed compound HID signal;
wherein, said preprogrammed compound HID signal comprising at least two elements from the group comprising at least mouse key event, scroll wheel event and pointer movement arranged in a chorded or temporal sequence fashion is permanent to said device and generated by a unique means without user composing manually.

2. In claim 1, said preprogrammed compound HID key event signal is for user data input purpose.

3. In claim 1, said input device further comprising means preventing said preprogrammed compound HID key event signal altered by user operations.

4. In claim 1, said input device further comprising a pointer control means;

5. In claim 1, said input device further comprising at least a rotational encoder or a joggle switch.

6. In claim 1, said input device further comprising a display unit.

7. In claim 1, said input device further comprising a touch input means.

8. In claim 1, said input device further comprising a barrel shaped body.

9. A system comprising a computing unit, a display unit and a memory unit coupled to a plurality of independently operated input device units without mutual interference; wherein each of said input device units comprising:
a data transmission module;
a body; and
a signal generating means capable of generating a plurality of preprogrammed single HID mouse key event signals and compound HID signals;
wherein, said compound HID signals are standard protocol compliant signals comprising at least two single HID mouse related event or movement elements from the group comprising at least mouse key event, scroll wheel event and pointer movement.

10. In claim 9, said system extracting user input data from said compound HID key event signals and/or said single HID mouse key event signals.

11. In claim 9, said system further comprising means identifying at least two said coupled input device units.

12. In claim 9, each of said input device units further comprising a pointer control means.

13. In claim 9, each of said input device units further comprising at least a rotational encoder or a joggle switch.

14. In claim 9, each of said input device units further comprising means to prevent said preprogrammed compound HID signals to be altered by user.

15. In claim 9, each of said input device units further comprising a display unit.

16. In claim 9, each of said input device units further comprising a touch input means.

17. In claim 9, said system further comprising means to remove or modify at least one of said single HID mouse key event signals and/or compound HID signals generated by said signal generating means.

18. A electronic data input method comprising the steps of:
generating a compound HID signal based standard protocol compliant code;
transmitting said protocol compliant code to a memory;
processing said protocol compliant code in said memory to extract user data; and
inputting said extracted user data to corresponding application.

19. In claim 18, said compound HID signal comprises at least one element from the group comprising a chorded HID key event, a temporal sequence of HID key events, a pointer movement signal and a scroll wheel action event.

20. In claim 18, said transmitting step further comprises a step to verify user data before transmitting.
